(19) United States
(12) Patent Application Publication
(10) Pub. No.: US 2014/0213681 A1
(43) Pub. Date: Jul. 31, 2014

(54) Method for Preparing Polycarbonate Resin

(71) Applicant: Cheil Industries Inc., Gumi-si (KR)

(72) Inventors: Jin Yong BAE, Uiwang-si (KR); Kyu Buem CHOI, Uiwang-si (KR); Su Jeong SONG, Uiwang-si (KR); Ho Sub LIM, Uiwang-si (KR); Bok Nam JANG, Uiwang-si (KR)

(73) Assignee: Cheil Industries Inc., Gumi-si (KR)

(21) Appl. No.: 14/168,098

(22) Filed: Jan. 30, 2014

(30) Foreign Application Priority Data
Jan. 30, 2013 (KR) 10-2013-0010679

(51) Int. Cl. C08G 64/06

(52) U.S. Cl. CPC C08G 64/06
USPC 521/180

(57) ABSTRACT

A method for preparing a polycarbonate resin includes polymerizing an aromatic dihydroxyl compound and a diaryl carbonate to prepare a polycarbonate pre-polymer; injecting and mixing an inert gas with the prepared polycarbonate pre-polymer; and foaming and polymerizing the polycarbonate pre-polymer with which the inert gas is mixed. The method can prevent or reduce yellowing upon melt polymerization of the polycarbonate resin.

### CROSS-REFERENCE TO RELATED APPLICATION

This application claims priority under 35 USC Section 119 to and the benefit of Korean Patent Application No. 10-2013-0010679, filed Jan. 30, 2013, the entire disclosure of which is incorporated herein by reference.

### FIELD OF THE INVENTION

The present invention relates to a method of preparing a polycarbonate resin.

### BACKGROUND OF THE INVENTION

Polycarbonate resins have excellent mechanical strength, heat resistance, impact resistance, transparency, and the like. For this reason, polycarbonate resins are widely used in exterior materials for office automation equipment, disks, transparent sheets, impact resistance films, and the like, and the demand for the polycarbonate resins is continuously increasing.

Polycarbonate resins are generally prepared by melt polymerization or surface polymerization. Surface polymerization is performed at low temperatures, and thus the polycarbonate resin prepared by surface polymerization has advantages, such as excellent color and easy control of the molecular weight of the resin, thereby allowing preparation of high viscosity products. However, since surface polymerization employs chlorine solvents and caustic soda, the presence of such chlorine solvents and caustic soda in final products affects the quality of the products, which requires many washing stages. Further, since phosgene is used as a raw material, surface polymerization causes environmental problems.

Accordingly, the use of polycarbonate resins obtained by melt polymerization is increasing in recent years. For melt polymerization, bisphenol A, diphenyl carbonate, and the like are used as raw materials of the polycarbonate resin. Since phenols are generated as by-products, melt polymerization is environmentally friendly as compared with surface polymerization.

When a polycarbonate resin is prepared by melt polymerization, effective removal of by-products such as phenols and the like generated upon transesterification is the most essential issue in view of resin productivity. Since the polycarbonate resin has high viscosity for its molecular weight, high temperature and high vacuum are required to enhance removal of phenols generated as by-products. Since removal of phenols is influenced by performance of a vacuum pump and sealing of a reactor in a high vacuum, increase in the temperature of the reactor and pipes is an easy way to remove phenols.

However, in melt polymerization, if a catalyst and oxygen or an iron component are present under conditions of high temperature and reduced pressure (for example, about 200° C. to about 320° C., and about 0.3 torr to about 100 torr) for removing phenols and the like, the polycarbonate resin can be modified by side reaction. This results in formation of a chromophore, thereby rendering the color of the base resin yellowish as compared with that of the polycarbonate resin prepared by surface polymerization.

In order to solve these problems, Japanese Patent Publication Nos. 2003-246853 and 2004-091695 disclose a method for performing solid phase polymerization in the presence of an inert gas after preparing a crystalline pre-polymer. However, this method has a problem in that mass production cannot be achieved, thereby remaining in only developmental stage. Further, Japanese Patent Publication No. 2000-136240 discloses a method of reducing the amount of an alkali metal catalyst and using an organic catalyst decomposed at high temperatures in order to inhibit the formation of a branched polycarbonate causing reduction in catalyst amount remaining in a final product and coloring. However, such a method has a drawback in that the reaction temperature must be further increased due to shortage of catalytic activity in later polymerization.

### SUMMARY OF THE INVENTION

The present invention provides a method of preparing a polycarbonate resin which may prevent or reduce yellowing of a polycarbonate resin during melt polymerization, for example at a temperature ranging from about 200° C. to about 320° C., and/or may remove by-products such as phenols and the like under polymerization conditions, for example of about 280° C. or less.

The method includes polymerizing an aromatic dihydroxyl compound and a diaryl carbonate to prepare a polycarbonate pre-polymer; injecting and mixing an inert gas with the prepared polycarbonate pre-polymer; and foaming and polymerizing the polycarbonate pre-polymer with which the inert gas is mixed.

In one embodiment, the polymerization to prepare the polycarbonate pre-polymer may be performed at a temperature ranging from about 160° C. to about 300° C. and at a pressure ranging from about 0.1 torr to about 100 torr.

In one embodiment, the injecting and mixing an inert gas may be performed at a temperature ranging from about 240° C. to about 300° C. and at a pressure ranging from about 0.1 MPa to about 4 MPa.

In one embodiment, the foaming and polymerizing may be performed at a temperature ranging from about 240° C. to about 300° C. and at a pressure ranging from about 0.1 torr to about 5 torr.

In one embodiment, the method of preparing a polycarbonate resin includes: polymerizing the aromatic dihydroxyl compound and the diaryl carbonate in a first reaction bath to prepare a first polycarbonate pre-polymer; polymerizing the first polycarbonate pre-polymer in a second reaction bath to prepare a second polycarbonate pre-polymer; polymerizing the second polycarbonate pre-polymer in a third reaction bath to prepare a third polycarbonate pre-polymer; injecting and mixing an inert gas with the third polycarbonate pre-polymer; and foaming and polymerizing the third polycarbonate pre-polymer with which the inert gas is mixed in a fourth reaction bath.

In one embodiment, the aromatic dihydroxyl compound may be represented by Formula 1:

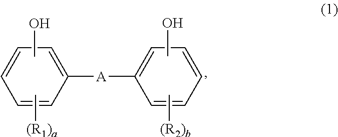

wherein A is a single bond, a substituted or unsubstituted C₁ to C₃₀ hydrocarbon group, —CO—, —S—, or —SO₂—; R₁ and R₂ are the same or different and are each independently substituted or unsubstituted C₁ to C₃₀ alkyl or substituted or unsubstituted C₆ to C₃₀ aryl; and a and b are the same or different and are each independently an integer from 0 to 4.

In one embodiment, the diaryl carbonate may be represented by Formula 2:

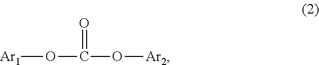

wherein Ar₁ and Arₑ are the same or different and are each independently substituted or unsubstituted C₆ to C₂₀ aryl.

In one embodiment, the aromatic dihydroxyl compound and the diaryl carbonate may be present in a mole ratio (aromatic dihydroxyl compound:diaryl carbonate) of about 1: about 0.9 to about 1:about 1.3.

In one embodiment, the inert gas may include nitrogen, argon, helium, or a combination thereof.

In one embodiment, the amount of the inert gas injected may be about 0.1 parts by weight to about 20 parts by weight based on about 100 parts by weight of the aromatic dihydroxyl compound and diaryl carbonate.

In one embodiment, the polycarbonate pre-polymer may have a weight average molecular weight ranging from about 2,000 g/mol to about 19,000 g/mol.

In one embodiment, the polycarbonate resin may have a weight average molecular weight ranging from about 20,000 g/mol to about 35,000 g/mol.

In one embodiment, the polycarbonate resin may have a yellow index (YI) of about 3.5 or less.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

A method of preparing a polycarbonate resin according to the present invention may include: (A) polymerizing an aromatic dihydroxyl compound and a diaryl carbonate to prepare a first polycarbonate pre-polymer; (B) injecting and mixing an inert gas with the prepared polycarbonate pre-polymer; and (C) foaming and polymerizing the polycarbonate pre-polymer with which the inert gas is mixed.

As used herein, the term “pre-polymer” refers to a polymer having a molecular weight lower than a final polymer produced during multistage polymerization procedures. For example, the “pre-polymer” may have a weight average molecular weight ranging from about 2,000 g/mol to about 19,000 g/mol.

### (A) Preparation of Polycarbonate Pre-Polymer

The preparation of the polycarbonate pre-polymer according to the present invention includes (melt) polymerization of an aromatic dihydroxyl compound and a diaryl carbonate to prepare a polycarbonate pre-polymer, wherein the aromatic dihydroxyl compound and diaryl carbonate may be reacted to generate an aromatic hydroxyl compound such as phenols and the like as by-products.

In one embodiment, the preparation of the polycarbonate pre-polymer may be performed after mixing the aromatic dihydroxyl compound and diaryl carbonate through a typical raw material mixing process prior to polymerization. For example, the raw material mixing process may be performed at about 140° C. to about 250° C., for example, about 160° C. to about 240° C., for about 1 hour to about 10 hours, wherein the conversion rate of the aromatic dihydroxyl compound may be about 70% or more, and the conversion rate of the diaryl carbonate may be about 65% or more. Within this range, polymerization and process stability can be ensured.

The polymerization can be performed at about 160° C. to about 300° C., for example, at about 200° C. to about 300° C., and as another example from about 240° C. to about 290° C., and at a pressure of about 0.1 torr to about 100 torr, for example, about 0.3 torr to about 50 torr, for about 1 hour to about 10 hours. Within this range, it is possible to prepare a polycarbonate pre-polymer having a weight average molecular weight ranging from about 2,000 g/mol to about 19,000 g/mol, for example, from about 2,500 g/mol to about 15,000 g/mol.

Further, in order to achieve efficient removal of phenols, the polymerization may be performed through 2 stages or more. For example, as described in Examples, the aromatic dihydroxyl compound and the diaryl carbonate can be polymerized in a first reaction bath to prepare a first polycarbonate pre-polymer; the first polycarbonate pre-polymer can be polymerized in a second reaction bath to prepare a second polycarbonate pre-polymer; and the second polycarbonate pre-polymer can be polymerized in a third reaction bath to prepare a third polycarbonate pre-polymer.

The first reaction bath may be under conditions of about 160° C. to about 240° C., for example, about 180° C. to about 230° C., and about 50 torr to about 100 torr, for example, about 60 torr to about 90 torr; the second reaction bath may be under conditions of about 240° C. to about 300° C., for example, about 250° C. to about 280° C., and about 10 torr to about 50 torr, for example, about 15 torr to about 40 torr; and the third reaction bath may be under conditions of about 240° C. to about 300° C., for example, about 250° C. to about 290° C., and about 0.1 torr to about 10 torr, for example, about 0.3 torr to about 5 torr. Within this range, change of the polymer into a yellowish color can be prevented.

Further, the by-products such as phenols and the like generated during polymerization may be recovered by a typical method.

As the aromatic dihydroxyl compound used in the present invention, a typical aromatic dihydroxyl compound used in preparation of the polycarbonate may be use. For example, a compound represented by Formula 1 may be used:

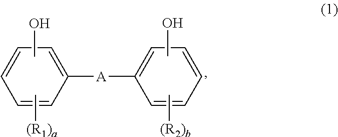

wherein A is a single bond, a substituted or unsubstituted C₁ to C₃₀ hydrocarbon group, —CO—, —S—, or —SO₂—; R₁ and R₂ are the same or different and are each independently substituted or unsubstituted C₁ to C₃₀ alkyl or substituted or unsubstituted C₆ to C₃₀ aryl; and a and b are the same or different and are each independently an integer from 0 to 4.

As used herein, the term “hydrocarbon group” refers to a C₁ to C₃₀ linear, C₄ to C₃₀ branched and/or C₅ to C₃₀ cyclic unsaturated hydrocarbon group, unless otherwise stated. Further, the term “substituted” means that at least one hydrogen atom is substituted with a substituent such as halogen, C₁ to C₃₀ alkyl, C₁ to C₃₀ haloalkyl, C₆ to C₃₀ aryl, C₂ to C₃₀ heteroaryl, C₁ to C₂₀ alkoxy, or a combination thereof.

In one embodiment, A is a single bond, substituted or unsubstituted C₁ to C₃₀ alkylene, substituted or unsubstituted C₂ to C₅ alkenylene, substituted or unsubstituted C₂ to C₅ alkylidene, substituted or unsubstituted C₅ to C₆ cycloalkylene, substituted or unsubstituted C₅ to C₆ cycloalkenylene, substituted or unsubstituted C₅ to C₁₀ cycloalkylidene, substituted or unsubstituted C₆ to C₃₀ arylene, substituted or unsubstituted C₁ to C₂₀ alkoxylene, a halogen acid ester group, a carbonic ester group, —CO—, —S—, or —SO₂—; R₁ and R₂ are the same or different and are each independently substituted or unsubstituted C₁ to C₃₀ alkyl, for example, C₁ to C₁₀ alkyl, or substituted or unsubstituted C₆ to C₃₀ aryl, for example, C₆ to C₁₀ aryl.

Examples of the aromatic dihydroxyl compound may include without limitation 2,2-bis-(4-hydroxyphenyl)-propane (referred to be as ‘bisphenol A’), 4,4′-biphnol, 2,4-bis-(4-hydroxyphenyl)-2-methylbutane, 1,1 -bis-(4-hydroxyphenyl)-cyclohexane, 2,2-bis-(3-chloro-4-hydroxyphenyl)-propane, 2,2-bis-(3,5-dichloro-4-hydroxyphenyl)-propane, and the like, and combinations thereof. For example, 2,2-bis-(4-hydroxyphenyl)-propane may be used.

A typical diaryl carbonate used in preparation of polycarbonate can be used as the diaryl carbonate used in the present invention. For example, a compound represented by Formula 2 may be used.

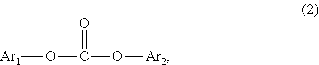

wherein Ar₁ and Ar₂ are the same or different and are each independently substituted or unsubstituted C₆ to C₂₀ aryl, for example, C₆ to C₁₀ aryl.

Examples of the diaryl carbonate may include without limitation diphenyl carbonate, ditolyl carbonate, bis(chlorophenyl) carbonate, m-cresyl carbonate, dinaphtyl carbonate, bis(diphenyl) carbonate, diethyl carbonate, dimethyl carbonate, dipropyl carbonate, dibutyl carbonate, methylethyl carbonate, methylpropyl carbonate, ethylpropyl carbonate, dicyclohexyl carbonate, and the like, and combinations thereof. For example, diphenyl carbonate may be used.

In one embodiment, the aromatic dihydroxyl compound and the diaryl carbonate may be present in a mole ratio (aromatic dihydroxyl compound:diaryl carbonate) of about 1:about 0.9 to about 1:about 1.3, for example, about 1:about 0.95 to about 1:about 1.25. Within this range, the content of unreacted monomers can be reduced, and reactivity due to the content of terminal structure can be optimized.

The polymerization according to the present invention may be performed in the presence of a catalyst. As the catalyst, a typical catalyst used in melt polymerization of polycarbonate resins may be used. For example, an alkali metal catalyst, an alkaline earth metal catalyst, and the like may be used. Examples of the alkali metal catalyst may include without limitation LiOH, NaOH, KOH, and the like. These are used alone or in combination thereof.

In one embodiment, the catalyst may be added in an amount of about 1×10⁻⁷ parts by weight to about 1×10⁻⁴ parts by weight based on about 100 parts by weight of the diaryl carbonate, without being limited thereto.

### (B) Injecting and Mixing of Inert Gas

In this invention, the step of injecting and mixing an inert gas includes injecting an inert gas having a low viscosity into the prepared polycarbonate pre-polymer and homogenizing the same. The mixed inert gas is expanded to increase a surface area of the polycarbonate pre-polymer, thereby facilitating discharge of by-products such as phenols and the like at a much lower temperature upon polymerization of the polycarbonate resin. Accordingly, it is possible to prevent coloring of the polycarbonate resin due to high temperatures while maintaining productivity of the polycarbonate resin.

In one embodiment, the step of injecting and mixing an inert gas may be performed by injecting an inert gas into a middle section of a pipe transferring the polycarbonate pre-polymer to a reactor for foaming and polymerizing the polycarbonate pre-polymer (step C) and mixing the polycarbonate pre-polymer with the inert gas. Here, a mixer may be provided such that the inert gas can be uniformly and compactly dispersed in the polycarbonate pre-polymer having a low molecular weight, and the mixer may be made of the same materials as the pipe and has the same inner diameter as that of the pipe in order to prevent increase in dwell time of the polycarbonate pre-polymer while the polycarbonate pre-polymer mixed with the inert gas is transferred through a pump. Then, the polycarbonate pre-polymer to which the inert gas is uniformly injected and dispersed is supplied to the reactor for foaming and polymerization, wherein the inert gas in the polycarbonate pre-polymer may be expanded by low pressure of the reactor. At this point, the surface area of the foamed polycarbonate pre-polymer is increased in direct proportion to a space receiving the inert gas and a migration passage. The by-products such as phenols and the like generated in the course of the foaming and polymerizing step (step C) may be easily discharged from the polycarbonate resin due to the increased surface area, whereby a polycarbonate resin having a high molecular weight may be prepared even at low temperatures.

In one embodiment, the step of injecting and mixing an inert gas may be performed at a temperature of about 240° C. to about 300° C., for example, about 250° C. to about 290° C., and a pressure of about 0.1 MPa to about 4 MPa, for example, about 0.2 MPa to about 3 MPa, for about 1 hour to about 10 hours. Within this range, the inert gas may be uniformly dispersed in and mixed with the polycarbonate pre-polymer.

Examples of the inert gas may include without limitation nitrogen, argon, helium, and the like, and combinations thereof. For example, nitrogen gas may be used.

The inert gas may be injected in an amount of about 0.1 parts by weight to about 20 parts by weight, for example, about 0.1 parts by weight to about 10 parts by weight, based on about 100 parts by weight of the aromatic dihydroxyl compound and the diaryl carbonate. In some embodiments, the inert gas may be injected in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20 parts by weight. Further, according to some embodiments of the present invention, the amount of the inert gas can be in a range from about any of the foregoing amounts to about any other of the foregoing amounts.

Within this range, the inert gas can be uniformly injected into and dispersed in the polycarbonate pre-polymer, and the polycarbonate pre-polymer to which the inert gas is uniformly injected may be sufficiently subjected to foaming, thereby enabling easy discharge of by-products such as phenols and the like.

### (C) Foaming and Polymerizing

According to the present invention, in the step of foaming and polymerizing (the preparing a polycarbonate resin), the temperature may be reduced at a temperature lower than a typical polymerization temperature of polycarbonate resin. For example, the polycarbonate pre-polymer to which the inert gas is injected may be subjected to foaming at a polymerization temperature of about 280° C. or less, thereby enabling easy removal of aromatic hydroxyl compounds (by-products) such as phenols, thereby providing a polycarbonate resin having a high molecular weight.

The step of foaming and polymerizing may be performed at a temperature of about 240° C. to about 300° C., for example, about 250° C. to about 290° C., and a pressure of about 0.1 torr to about 5 torr, for example, about 0.3 torr to about 2 torr, for about 1 hour to about 10 hours. Within this range, yellowing of the polycarbonate resin can be prevented or reduced, and a polycarbonate resin having a high molecular weight can be prepared through rapid removal of by-products without decreasing productivity even under polymerization conditions of about 280° C. or less.

Further, the step of foaming and polymerizing may be performed at the same time, or polymerization may be performed after foaming. The by-products such as phenols and the like may be recovered by a typical method.

The polycarbonate resin according to the present invention may have a weight average molecular weight (Mw) of about 20,000 g/mol to about 35,000 g/mol, as measured by GPC (gel permeation chromatography), which is identical to that of polycarbonate resins prepared by typical melt polymerization. In addition, the polycarbonate resin according to the present invention may have the same or close to melt index and impact resistance as those of the polycarbonate resins prepared by typical melt polymerization.

The polycarbonate resin may have a yellow index (YI) of about 3.5 or less, for example, about 3.3 or less, and as another example from about 1 to about 3.2. Within this range, yellowing of the polycarbonate resin can be prevented or reduced.

The polycarbonate resin according to the present invention may be prepared using a typical melt polymerization reactor through continuous or batch polymerization except that a device for injecting and mixing the inert gas is provided to a middle section of a pipe connected to the reactor for step A and step C. Further, the polycarbonate resin may be subjected to melt extrusion in an extruder to form pellets as in typical polycarbonate resins. The prepared pellets may be formed into various molded articles (products) through various molding methods including injection molding, extrusion molding, vacuum molding, cast molding, and the like. Such molding methods are known to those skilled in the art.

Next, the present invention will be better appreciated from the following examples. It should be understood that these examples are provided for illustration only and are not to be construed in any way as limiting the scope of the present invention.

### EXAMPLE

### Example 1

To a first mixing bath maintained at a temperature of 160° C., 172 kg of bisphenol A (BPA), 178 kg of diphenyl carbonate (DPC), and 100 ppb (/BPA, weight) of a catalyst (KOH) are charged, followed by heating to 190° C. and stirring for 6 hours to mix the raw materials. The conversion rate of bisphenol A is 75% or more, and the conversion rate of diphenyl carbonate is 65% or more. Subsequently, the mixture is transferred to a first polymerization bath at a rate of 14.5 kg/hr to initiate continuous reaction. The first polymerization bath in main reaction is under conditions of 220° C., 70 torr, and an average dwell time of 1 hour. Next, the polymerized mixture is continuously transferred to a second polymerization bath under conditions of 265° C., 30 torr and an average dwell time of 1 hour. Next, the resulting material is continuously transferred to a third polymerization bath under conditions of 265° C., 4.5 torr and an average dwell time of 1 hour. A device for injecting and mixing an inert gas (L =1,000 mm, D =76.2 mm) is provided to a pipe connecting the third polymerization bath and the fourth polymerization bath, followed by supplying nitrogen gas at a rate of 0.3 Nm/hr to inject and disperse the nitrogen gas in the polycarbonate pre-polymer transferred to the third polymerization bath. The nitrogen gas is injected in an amount of 1.5 parts by weight based on 100 parts by weight of the aromatic dihydroxyl compound (BPA) and the diaryl carbonate (DPC). The device for injecting and mixing inert gas is maintained under conditions of 265° C. and 1 MPa. Next, the polycarbonate pre-polymer in which the nitrogen gas is injected and dispersed is continuously transferred to a fourth polymerization bath under conditions of 265° C., 0.38 torr, and an average dwell time of 1 hour. Subsequently, the final polymerized material is supplied to an extruder to prepare a pelletized polycarbonate resin.

### Example 2

A polycarbonate resin is prepared in the same manner as in Example 1 except that the pipe from the third polymerization bath to the fourth polymerization bath, the reactor, and the device for injecting and mixing the inert gas are maintained at 270° C.

### Example 3

A polycarbonate resin is prepared in the same manner as in Example 1 except that the pipe from the third polymerization bath to the fourth polymerization bath, the reactor, and the device for injecting and mixing the inert gas are maintained at 275° C.

### Example 4

A polycarbonate resin is prepared in the same manner as in Example 1 except that the pipe from the third polymerization bath to the fourth polymerization bath, the reactor, and the device for injecting and mixing the inert gas are maintained at 280° C.

### Example 5

A polycarbonate resin is prepared in the same manner as in Example 1 except that the pipe from the third polymerization bath to the fourth polymerization bath, the reactor, and the device for injecting and mixing the inert gas are maintained at 285° C.

### Comparative Example 1

To a first mixing bath maintained at a temperature of 160° C., 172 kg of bisphenol A (BPA), 178 kg of diphenyl carbonate (DPC), and 100 ppb (/BPA, weight) of a catalyst (KOH) are charged, followed by heat to 190° C. and stirring for six hours to mix the materials. The conversion rate of bisphenol A is 75% or more, and the conversion rate of diphenyl carbonate is 65% or more. Subsequently, the mixture is transferred to a first polymerization bath at a rate of 14.5 kg/hr to initiate continuous reaction. The first polymerization bath in main reaction is under conditions of 220° C., 70 torr, and an average dwell time of 1 hour. Next, the polymerized mixture is continuously transferred a second polymerization bath under conditions of 265° C., 30 torr, and an average dwell time of 1 hour. Next, the polymerized mixture is continuously transferred a third polymerization bath under conditions of 280° C., 4.5 torr and an average dwell time of 1 hour. Next, the polymerized mixture is continuously transferred a fourth polymerization bath under conditions of 280° C., 0.38 torr and an average dwell time of 1 hour. Subsequently, the final polymerized material is supplied to an extruder to prepare a pelletized polycarbonate resin.

### Comparative Example 2

A polycarbonate resin is prepared in the same manner as in Comparative Example 1 except that the pipe from the third polymerization bath to the fourth polymerization bath and the reactor are maintained at 290° C.

### Evaluation of Physical Properties

(1) Weight average molecular weight (Mw, unit: g/mol): Weight average molecular weight is measured using methyl chloride solvent in accordance with GPC-TDA (Viscotek Co., Ltd.).

(2) Melt index (MI, unit: g/10 min): Melt index is measured at 300° C./1.2kg using a modular melt flow testing equipment of CEAST Co., Ltd.

(3) Yellow index (YI): The polycarbonate resins prepared in Examples and Comparative Examples are dried at 120° C. for 4 hours, followed by injection molding using a 10 oz injection molding machine under a cylinder temperature of 290° C. and a mold temperature of 70° C. to prepare 3 mm thick specimens. Yellow index is measured on a specimen for five times using a colorimeter ND-1001 DP (Nippon Denshoku Kogyo K. K) and averaged.

TABLE 1

| | | | | | | Comparative | |
|---|---|---|---|---|---|---|---|
| | Example | | | | | Example | |
| | 1 | 2 | 3 | 4 | 5 | 1 | 2 |
| Molecular weight (Mw) at outlet | 12,014 | 12,283 | 12,549 | 12,901 | 13,472 | 12,659 | 13,274 |
| of third polymerization bath | | | | | | | |
| Molecular weight (Mw) at outlet | 23,316 | 24,491 | 25,715 | 28,716 | 32,231 | 25,751 | 29,641 |
| of fourth polymerization bath | | | | | | | |
| Yellow index (YI) | 2.00 | 2.21 | 2.52 | 2.86 | 3.29 | 3.59 | 4.27 |
| Melt index (MI) | 17.4 | 13.7 | 9.7 | 7.1 | 4.1 | 10.5 | 6.3 |

From the results of Table 1, it can be seen that the polycarbonate resins prepared at a low temperature ranging from 265° C. to 285° C. by the method according to the present invention have a weight average molecular weight (molecular weight (Mw) at an outlet of the fourth polymerization bath) and melt index (MI) similar to those of typical polycarbonate resins prepared at 280° C. to 290° C., thereby ensuring productivity while significantly lowering yellow index by 3.5 or less. Further, it can be seen that, under the same temperature conditions (Example 4 and Comparative Example 1), the method according to the present invention allows easy removal of phenols providing polycarbonate resins having a high molecular weight.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A method of preparing a polycarbonate resin, comprising:
polymerizing an aromatic dihydroxyl compound and a diaryl carbonate to prepare a polycarbonate pre-polymer;
injecting and mixing an inert gas with the prepared polycarbonate pre-polymer; and
foaming and polymerizing the prepared polycarbonate pre-polymer with which the inert gas is mixed.

2. The method of preparing a polycarbonate resin according to claim 1, wherein the step of polymerizing an aromatic dihydroxyl compound and a diaryl carbonate to prepare a polycarbonate pre-polymer is performed at a temperature of about 160° C. to about 300° C. and a pressure of about 0.1 torr to about 100 torr.

3. The method of preparing a polycarbonate resin according to claim 1, wherein the step of injecting and mixing an inert gas is performed at a temperature of about 240° C. to about 300° C. and a pressure of about 0.1 MPa to about 4 MPa.

4. The method of preparing a polycarbonate resin according to claim 1, wherein the step of foaming and polymerizing the polycarbonate pre-polymer is performed at a temperature of about 240° C. to about 300° C. and a pressure of about 0.1 torr to about 5 torr.

5. The method of preparing a polycarbonate resin according to claim 1, comprising:
polymerizing the aromatic dihydroxyl compound and the diaryl carbonate in a first reaction bath to prepare a first polycarbonate pre-polymer;
polymerizing the first polycarbonate pre-polymer in a second reaction bath to prepare a second polycarbonate pre-polymer;
polymerizing the second polycarbonate pre-polymer in a third reaction bath to prepare a third polycarbonate pre-polymer;
injecting an inert gas to the third polycarbonate pre-polymer and mixing the inert gas with the third polycarbonate pre-polymer; and
foaming and polymerizing the polycarbonate with which inert gas is mixed in a fourth reaction bath.

6. The method of preparing a polycarbonate resin according to claim 1, wherein the aromatic dihydroxyl compound is represented by Formula 1: 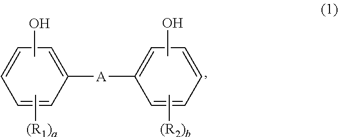
wherein A is a single bond, a substituted or unsubstituted C₁ to C₃₀ hydrocarbon group, —CO—, —S—, or —SO₂—; R₁ and R₂ are the same or different and are each independently substituted or unsubstituted C₁ to C₃₀ alkyl, or substituted or unsubstituted C₆ to C₃₀ aryl; a and b are the same or different and are each independently an integer from 0 to 4.

7. The method of preparing a polycarbonate resin according to claim 1, wherein the diaryl carbonate is represented by Formula 2: 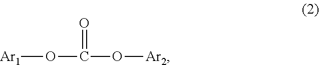
wherein Ar₁ and Ar₂ are the same or different and are each independently substituted or unsubstituted C₆ to C₂₀ aryl.

8. The method of preparing a polycarbonate resin according to claim 1, wherein the aromatic dihydroxyl compound and the diaryl carbonate are present in a mole ratio (aromatic dihydroxyl compound:diaryl carbonate) of about 1:about 0.9 to about 1:about 1.3.

9. The method of preparing a polycarbonate resin according to claim 1, wherein the inert gas comprises nitrogen, argon, helium, or a combination thereof.

10. The method of preparing a polycarbonate resin according to claim 1, wherein the step of injecting the inert gas comprises injecting the inert gas in an amount of about 0.1 parts by weight to about 20 parts by weight based on about 100 parts by weight of the aromatic dihydroxyl compound and the diaryl carbonate.

11. The method of preparing a polycarbonate resin according to claim 1, wherein the polycarbonate pre-polymer has a weight average molecular weight ranging from about 2,000 g/mol to about 19,000 g/mol.

12. The method of preparing a polycarbonate resin according to claim 1, wherein the polycarbonate resin has a weight average molecular weight ranging from about 20,000 g/mol to about 35,000 g/mol.

13. The method of preparing a polycarbonate resin according to claim 1, wherein the polycarbonate resin has a yellow index (YI) of about 3.5 or less.
